(19) United States
(12) Patent Application Publication
(10) Pub. No.: US 2013/0184013 A1
(43) Pub. Date: Jul. 18, 2013

(54) METHOD, NETWORK DEVICE AND TERMINAL DEVICE FOR PAGING TERMINAL DEVICES

(71) Applicants: Hua Chao, PuDong Jinqiao Shanghai (CN); Yonggang Wang, PuDong Jinqiao Shanghai (CN); He Wang, PuDong Jinqiao Shanghai (CN); Zhongji Hu, PuDong Jinqiao Shanghai (CN)

(72) Inventors: Hua Chao, PuDong Jinqiao Shanghai (CN); Yonggang Wang, PuDong Jinqiao Shanghai (CN); He Wang, PuDong Jinqiao Shanghai (CN); Zhongji Hu, PuDong Jinqiao Shanghai (CN)

(73) Assignee: ALCATEL LUCENT, Paris (FR)

(21) Appl. No.: 13/876,284

(22) PCT Filed: Sep. 14, 2011
(86) PCT No.: PCT/IB2011/002467

§ 371 Date: Mar. 27, 2013

(30) Foreign Application Priority Data
Sep. 30, 2010 (CN) 201010298527.9

(51) Int. Cl. H04W 68/02

(52) U.S. Cl. CPC H04W 68/02
USPC 455/458

(57) ABSTRACT

The present invention proposes a new method, a network device, and a terminal device of paging a terminal device in a communication system. The receiving a paging initiation present invention determines the paged object based on the group ID and/or the device ID of the paged terminal device, further, defines a specific paging occasion for the terminal device having group function; at the specific paging occasion paging message comprising the group ID and/or the device ID of the paged terminal device is sent; further, paging reason is inserted into the paging message; wherein the terminal device receives the paging message at the specific paging occasion defined by the system; and further reads the paging reason and responds accordingly to complete the paging procedure after the group ID and/or the device ID of its own is read. This paging mechanism of this invention solves the problem of paging determining a paging a group of terminal devices. It can meet the requirement of paging a specific or a group of terminal devices. The paging efficiency is thereby improved, and no negative impact on the paging of the current network terminal device is introduced.

### FIELD OF THE INVENTION

The present invention relates to mobile communication technique, particularly relates to a method, a network device and a terminal device, for paging terminal devices in a communication system.

### BACKGROUND OF THE INVENTION

According to the current definition of communications system standards, paging for a terminal device is performed by determining the paged object based on the device ID of the terminal device. This is because the current communication system is originally designed for Human-to-Human (H2H) communication. The communication between a single calling user and a single called user accounts for the majority of the communication demands in daily life. However, with the fast development of the communication technique, applications of communication technique expand consistently, and the communication between a single calling user and multiple called users attracts more and more attentions, especially for Machine Type Communication (MTC) service. In a word, a user (including individual or business user) expects to communicate with multiple called users at the same time or trigger the same response of multiple called users. Under the circumstance of applying the paging technique and procedure in the current communication system, a practical solution is to initiate multiple independent paging procedures for the multiple called users, which leads to a waste of system resources.

Moreover, it should be considered that, there are more terminal devices in Machine Type Communication (MTC) service than in H2H communication, which is widely accepted. When MTC is introduced into the current communication system, the design of its paging mechanism is facing much more challenge, which is required to have the capability to page MTC device only and have no negative impact on legacy paging.

There is already a paging mechanism for H2H User Equipments (UEs). However, it cannot be applied to MTC service directly. Firstly, it cannot perform paging for MTC device only. Secondly, if H2H UEs and MTC device are paged at the same time, a large number of legacy UEs and MTC devices need to wake up at the same paging occasion (PO) and finally find the paging is not for itself, which means both terminal power waste and a higher probability of fake paging. At last, although current paging can page multiple UEs at the same paging occasion, the UE ID of each of them needs to be transmitted in the air interface, which is quite inefficient.

### SUMMARY OF THE INVENTION

In order to solve the problems described above, the present invention proposed a new method of paging terminal devices in the communication system comprising network devices and terminal devices. The present invention determines the paged object based on the group ID and/or the device ID of the paged terminal device, and the system defines a dedicated paging occasion for the terminal device which has group function; and at the dedicated paging occasion, a paging message comprising the group ID and/or the device ID of the paged terminal device is sent; further, a paging reason is inserted into the paging message; while the terminal device receives the paging message at the dedicated paging occasion defined by the system, and reads the paging reason and responds accordingly to complete the paging procedure after the group ID and/or the device ID of its own is detected. This paging mechanism in the invention solves the problem of paging a group of terminal devices; it can meet the requirement of paging a specific terminal device or a group of terminal devices effectively and flexibly, improving the efficiency and does not have negative impact on the paging of current network terminal devices.

Specifically, according to one embodiment of the present invention, a method of paging a terminal device in a communication system comprising network devices and terminal devices is provided, wherein, the method comprises:

receiving, by the network device, a paging initiation message;

determining, by the network device, a paged terminal device;

determining, by the network device, a paging occasion;

sending, by the network device, a physical layer paging indication and a paging message at a time corresponding to the paging occasion, detecting, by the terminal device, the physical layer paging indication at the paging occasion;

further, receiving the paging message, by the terminal device, which detects the physical layer paging indication at the corresponding paging occasion,.

According to an alternative embodiment of the present invention, the paging initiation message comprises the group ID and/or device ID of the paged terminal device, which is identified by its group ID or device ID; the paging occasion is determined by the group ID of the terminal device; the network device sends the group ID and/or device ID of the paged terminal device to the terminal device using the paging message; the terminal device which receives the paging message checks if the paging message comprises its group ID and/or device ID.

According to an alternative embodiment of the present invention, the paging initiation message further comprises an area information of the paged terminal device; and the network device determines a paging area in which the paging message is sent according to the area information of the paged terminal device; and sends the physical layer paging indication and the paging message to the paging area only.

According to an alternative embodiment of the present invention, the paging initiation message further comprises a paging reason; and based on the paging reason comprised in the paging initiation message, the network device further inserts the corresponding paging reason into the paging message, and informs the paged terminal device of the required operations; and the terminal device, which detects its group ID or device ID in the paging message, further acquires the paging reason indicated in the paging message, and then performs required procedures based on the paging reason.

According to an alternative embodiment of the present invention, the paging initiation message is originated from upstream network devices; the paging reason being call setup or uplink (UL) report; if the paging reason is call setup, the terminal device initiating a procedure to set up connection with the network for call; if the paging reason is uplink report, the terminal device feedbacking a uplink report.

According to an alternative embodiment of the present invention, the paging initiation message is originated from the operation and administration devices of the communication system; wherein the paging reason is system information acquisition, the corresponding operation of the terminal device according to the paging reason being reading the system information.

According to an alternative embodiment of the present invention, the communication system supports the Machine Type Communication service; the acquired system information is system information of the Machine Type Communication; the terminal device is a terminal device that supports the Machine Type Communication.

According to an alternative embodiment of the present invention, a network device which sends paging message in the communication system is provided, wherein the communication system comprises at least one terminal device with a group ID and a device ID, and the network device comprises:

a receiver, for receiving a paging initiation message, the paging initiation message comprises the group ID and/or device ID of the paged terminal device;

an apparatus, for determining paged terminal device, configured to determine a paged terminal device based on the paging initiation message, the paged terminal device being determined by its group ID or device ID;

an apparatus, for calculating paging occasion, configured to calculate a paging occasion based on the group ID of the paged terminal device;

an apparatus for generating physical layer data, configured to generate a physical layer control message which comprises a physical layer paging indication;

an apparatus for generating paging message, configured to generate a paging message which comprises the group ID and/or device ID of the paged terminal device;

a transmitter, for sending the physical layer information and the paging message at a time corresponding to the paging occasion.

According to one embodiment of the present invention, the paging initiation message received by the receiver further comprises a paging reason, and the apparatus for generating paging message further inserts the paging reason into the paging message.

According to an alternative embodiment of the present invention, the paging initiation message received by the receiver is originated from a network device that locates upper level of the network device; the paging reason is setup call or uplink report.

According to an alternative embodiment of the present invention, the paging initiation message received by the receiver is originated from the operation and administration devices of the communication system; the paging reason is system information acquisition.

According to an alternative embodiment of the present invention, the paging initiation message received by the network device further comprises an area information of the paged terminal device; and the network device also comprises a paging area determing apparatus, which is configured to determine a paging area, in which the paging message is sent, according to the area information of the paged terminal device; and according to the paging area exported by the paging area determing apparatus, the transmitter sends the physical layer information and the paging message to the paging area only.

According to an alternative embodiment of the present invention, the communication system supports the Machine Type Communication service; the network device is an access network device which supports the Machine Type Communication; the terminal device is a terminal device that supports the Machine Type Communication.

According to one embodiment of the present invention, a terminal device is provided, which comprises:

an apparatus for calculating paging occasion, configured to calculate a paging occasion;

a first receiver, for receiving a physical layer paging indication from a network device at the paging occasion;

a second receiver, for receiving a paging message after the first receiver receives the physical layer paging indication.

According to an alternative embodiment of the present invention, the terminal device also comprises:

an apparatus for identifying device identity, for identifying the ID of the terminal device, including group ID and device ID;

an apparatus for detecting device identity, for detecting if the paging message comprises the group ID and/or the device ID of the terminal device;

further, the apparatus for calculating paging occasion is for calculating the paging occasion based on the group ID of the terminal device.

According to an alternative embodiment of the present invention, the terminal device also comprises:

an apparatus for reading paging reason, configured to read the paging reason comprised in the paging message, when the apparatus for detecting device identity detects the group ID and/or the device ID of the terminal device;

an apparatus for processing paging reason, configured to perform corresponding process according to the paging reason.

According to an alternative embodiment of the present invention, when the paging reason is call setup, the apparatus for processing paging reason initiates a procedure to set up connection with the network for call.

According to an alternative embodiment of the present invention, when the paging reason is uplink report, the apparatus for processing paging reason feedbacks an uplink report.

According to an alternative embodiment of the present invention, when the paging reason is system information acquisition, the apparatus for processing paging reason reads the system information.

According to an alternative embodiment of the present invention, the terminal device is a terminal device that supports the Machine Type Communication; the group ID of the terminal device is a group ID of the Machine Type Communication service.

### BRIEF DESCRIPTION OF THE DRAWINGS

By reading the following detailed description of the non-restrictive embodiments in conjunction with the following figures, other features, objects and advantages of the present invention will be more apparent.

FIG. 1 shows a schematic view of the three-layer paging mechanism according to one embodiment of the present invention.

FIG. 2 shows a schematic view of the paging occasion and the paging cycle according to one embodiment of the present invention.

FIG. 3 shows a flow chat of the paging procedure of the network device according to one embodiment of the present invention.

FIG. 4 shows a flow chat of the paging procedure of the terminal device according to one embodiment of the present invention.

FIG. 5 shows a structural diagram of the network device according to one embodiment of the present invention.

FIG. 6 shows a structural diagram of the terminal device according to one embodiment of the present invention.

In the figures above, same reference numerals refer to the same, similar or corresponding characters or functions.

### DETAILED DESCRIPTION OF EMBODIMENTS

The detailed description of embodiments of the present invention will be given as below in conjunction with the figures.

It should be noted that the technical solution in the present invention is primarily adapted for the communication system supporting a terminal device that has group function, particularly, such as the communication system based on MTC, i.e. the terminal device is a MTC device, and the MTC terminal devices are grouped according to the application types they support. The technical solution in the present invention is also adapted for other communication systems and their terminal devices.

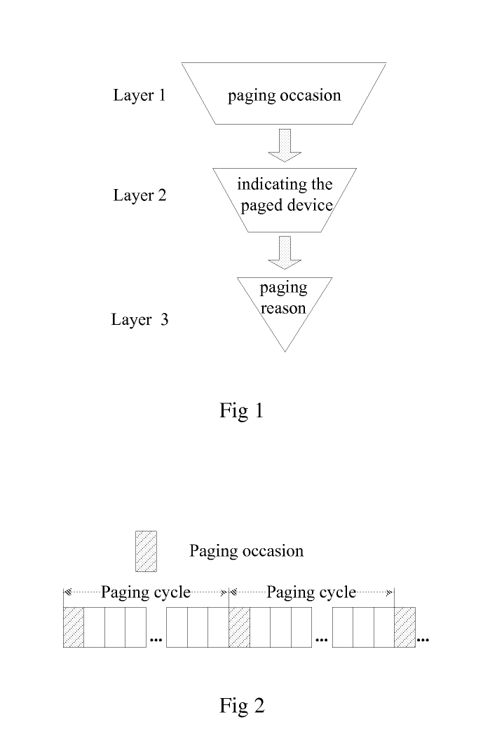

FIG. 1 shows a schematic view of the three-layer paging mechanism according to one embodiment of the present invention.

The terminal device that has group function carries identifiable group ID and device ID. Therefore, in the present invention the paged object is determined using the group ID and/or device ID of the terminal device. On this basis, a three-layer paging mechanism is proposed.

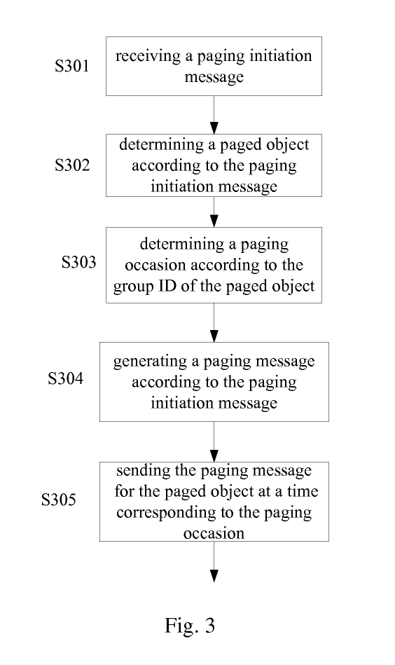

In the first layer, a paging occasion is defined in the present invention, the paging occasion refers to a specific sub-frame in a specific wireless frame of a certain device or a certain group of devices. In the present invention, the paging occasion is determined using the group ID of the terminal device. FIG. 2 shows a schematic view of the paging occasion and the paging cycle according to one embodiment of the present invention.

In the following, exemplary description will be given using an example where a MTC terminal device in the MTC service is paged.

MTC paging occasion appears periodically in the granularity of MTC paging cycle, which is an integer times of the wireless frame. MTC paging cycle is configured by the network, the MTC network may apply a different paging cycle for MTC compared to current H2H communication.

MTC paging occasion is determined using MTC group ID. The following manner may be applied, in which the system frame number (SFN) of a wireless frame is calculated according to the formula (1), while the number of sub-frame is defined by formula (2).

SFN mod T=(T/N)*(group ID mod N), (1)

i_{—}s=(group ID/N) mod Ns, (2)

wherein, T stands for paging cycle; N is the number of paging frames within a paging cycle configured by the network; i_s is sub-frame index; Ns is the number of paging sub-frames within a wireless frame. The specific method of calculating the paging occasion won't be discussed in the present invention.

The network device sends a physical layer paging indication at a time corresponding to the paging occasion; idle MTC device wakes up at the MTC paging occasion corresponding to its group ID, and detects the physical layer paging indication. If no paging indication is found, the paging procedure is finished. If there is one, the second-layer of the paging procedure is performed. At the specific paging occasion, only the terminal devices corresponding to the specific paging occasion wake up and then detect the physical layer paging indication. This aims to narrow down the paging range for specific MTC devices only; other terminal devices which are not paged remain idle to save power.

It should be noted that the MTC devices are same as the current H2H device in having its own user ID. MTC device also has its own MTC group ID based on different groups, the MTC device can acquire the group to which it belongs by means of OAM. The group ID is stored in SIM card of the device; the principles for MTC grouping may assign different MTC groups according to different applications of the MTC service, e.g. smart metering, vendor machine or public security. The principles for grouping devices are not limited thereto, which will also not be discussed here.

In the second layer, the paging message is sent in the air interface at the paging occasion to page expected devices. The group ID or device ID of the paged device is inserted in the paging message that is sent, so as to narrow down the paging range further, as only the terminal device which reads its own MTC group ID or device ID of its own continues to perform the third-layer procedure. Multiple groups of terminal devices or multiple terminal devices can be indicated in a single paging message which may be sent via Radio Resources Control (RRC). It depends on the cell structure of the paging message, whether the group ID of the paged object only or the device ID of the paged object only or both of them are carried in the paging message. It is possible that for a group of devices, the group ID is considered as a first level cell while the device ID as a second level cell, and it is also possible that these two IDs are independently cells of the same level. The present invention can be applied to cell structure design of various paging message, which will not be elaborated here.

Further, in the second layer, the network may send the paging message only in a determined paging area, which is determined according to the geographic area information of the paged object, which includes Cell ID, tracking area (TA) ID, location area (LA) ID or routing area (RA) ID. TA, RA and LA are administrated by the core network mobility and configured to enable the core network device to track, identify and control the geographic area where the terminal device is located, and which generally comprises one or a plurality of cells.

Still take MTC terminal device as example, paging message comprises MTC group ID and/or user ID of the MTC device to narrow down the paging range. A plurality of MTC groups or a plurality of MTC devices may be paged at the same paging occasion; it is determined in this layer which groups or devices are paged.

If the paging message comprises the MTC group ID, all the MTC devices belonging to this indicated group need to respond to the paging message; a single or a plurality of MTC devices can also be paged, which is implemented by carrying the MTC device ID in the paging message. If the paging message comprises the MTC device ID, only the indicated MTC device needs to respond the paging message, i.e. only the MTC terminal device which detects its own MTC group ID or device ID in the paging message continues to perform the third-layer procedure. If the MTC device does not detect its own group ID or device ID in the paging message, the paging procedure is finished.

In the third layer, the paged terminal devices are informed of what they are expected to do. In another word, this layer informs the paged terminal devices why the network initiated the paging; then the paged terminal devices respond accordingly. Paging reason is inserted in the paging message. Possible paging reason is call setup, uplink report, system information acquisition, while other paging reasons are not excluded here. If the paging reason is indicated as call setup, it means to request the paged device to set up connection with the network for call. If the paging reason is uplink report, the network wants the paged device to feedback a report. As for the system information acquisition, the network requests the terminal devices to read system information.

Take MTC terminal device as example, the MTC terminal device which detects its own group ID or device ID in the paging message at the second layer, further reads the paging reason in the paging message. If the paging reason is UL report, which means the network wants the paged device to feedback a report; as for the paging reason being the MTC system information acquisition, the network requests the MTC device to read system information to acquire MTC system information so as to acquire reconfiguration information for MTC service for example.

The following four embodiments respectively explain how the present invention is applied in different systems in detail.

The first embodiment describes a paging procedure for general WCDMA terminal devices having group function. In this embodiment, terminal devices belonging to one group are paged, and then informed of change of system information.

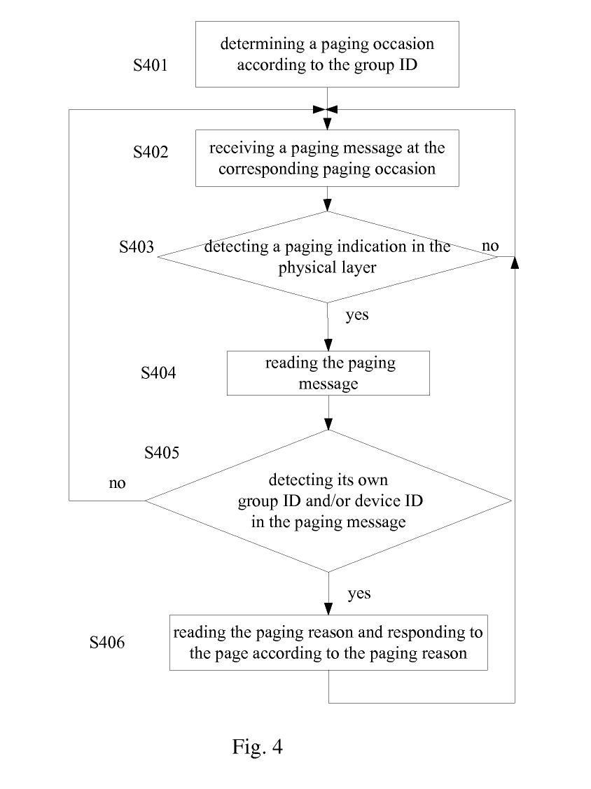

In conjunction with FIG. 3, activities of the network comprise:

In step S301, a NodeB (NB) receives a paging message originated from the operation and administration devices (OAM) of the WCDMA system, and the paging message comprises the information of paged object and the paging reason, wherein, the information of paged object is the group ID of a group of terminal devices and the paging reason is system information acquisition.

In step S302, the NB determines the paged objects based on the group ID of a group of terminal devices;

In step S303, the NB calculates the paging occasion based on the group ID of the terminal devices;

In step S304, the NB generates the paging message comprising the group ID of the paged object; and configures the system information change indication in the paging message using the technique in prior art;

In step S305, the NB sends the group-specific paging message via the air interface to all the cells that the NB administrates at the specific paging occasion. The NB sets and then sends the corresponding physical layer paging indication in the Page Indication Channel (PICH) in the physical layer.

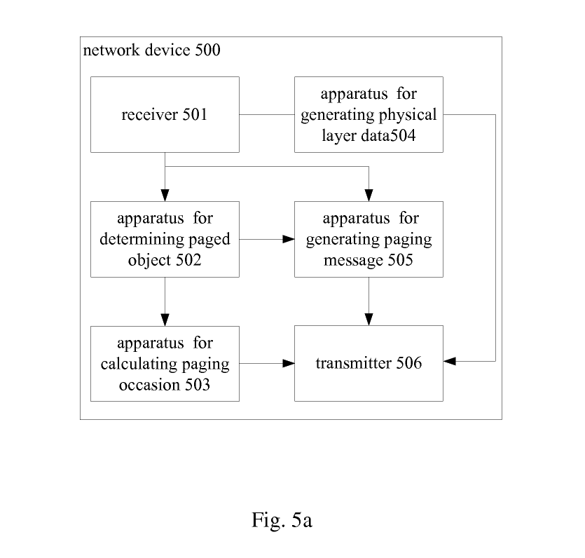

In conjunction with FIG. 4, activities of terminal device comprise:

In step S401, the terminal device calculates the paging occasion of the terminal device based on its own group ID;

In step S402, idle terminal device wakes up at the specific paging occasion. At other times, idle terminal device may turn off the receiver to preserve the battery power. The waked up terminal device monitors the physical downlink control channel (PDCCH);

In step S403, terminal device checks if there is a paging indication. If not, the terminal device ends the paging procedure, switches back to the idle mode and waits for the next paging occasion to wake up and monitor PDCCH; if paging indication is found, the terminal device executes the step S404;

In step S404, terminal device reads the paging message;

In step S405, terminal device checks if there is its own group ID and/or device ID in the paging message. If not, the terminal device ends the paging procedure, switches back to the idle mode and waits for the next paging occasion to wake up and monitor PDCCH; if its own group ID and/or device ID is read, the terminal device executes the step S406;

In step S406, terminal device reads the system information change indication, to respond to the paging, the terminal device reads all the system information and updates the corresponding parameters delivered in the system information;

The second embodiment describes a paging procedure for general Long Term Evolution (LTE) terminal devices having group function. In this embodiment, a single or a plurality of terminal devices belonging to one group are paged, and then required to set up call with the network.

In conjunction with FIG. 3, activities of network comprise:

In step S301, enhanced NodeB (eNB) receives the paging message originated from the mobility management entity (MME) which locates upstream, and the paging message comprises the information of paged object and the paging area; additionally, the paging reason is indicated as call setup. The information of paged object is the device ID(s) of a single or a plurality of terminal devices and the group ID of the group they belong to; the information of paging area is one or a plurality of TAs, i.e. a TA list.

In step S302, eNB determines the paged objects based on the device IDs of a single or a plurality of terminal devices; and determines the specific cell of the paging message based on the information of paging area;

In step S303, eNB calculates the paging occasion based on the group ID of the terminal device(s);

In step S304, eNB further determines that the paging reason is call setup; and generates the paging message comprising the group ID of the paged object and/or the device IDs of a single or a plurality of terminal devices and paging reason for call setup;

In step S305, eNB sends the group-specific paging message via the air interface to all the corresponding cells according to the TA list information at the specific paging occasion. The corresponding cells are all the cells comprised in the range indicated by TA. The eNB sets and then sends the corresponding physical layer paging indication in the PDCCH.

In conjunction with FIG. 4, activities of terminal device comprise:

In step S401, the terminal device calculates the paging occasion based on its own group ID;

In step S402, idle terminal device wakes up at the specific paging occasion. At other times, idle terminal device may turn off the receiver to preserve the battery power. The waked up terminal device monitors the PDCCH;

In step S403, terminal device checks if there is a paging indication. If not, the terminal device ends the paging procedure, switches back to the idle mode and waits for the next paging occasion to wake up and monitor PDCCH; if paging indication is found, the terminal device executes the step S404;

In step S404, terminal device reads the paging message;

In step S405, terminal device checks if there is its own device ID and/or group ID in the paging message. If not, the terminal device ends the paging procedure, switches back to the idle mode and waits for the next paging occasion to wake up and monitor PDCCH; if its own group ID and/or device ID is read, the terminal device executes the step S406;

In step S406, terminal device reads the paging reason and finds it out to be call setup; to respond to the paging; terminal device initiates a procedure to set up connection with the network for call.

The third embodiment describes a paging procedure for WCDMA MTC devices. In this embodiment, a group of MTC devices are paged, and are required to read MTC system information.

In conjunction with FIG. 3, activities of network comprise:

In step S301, Radio Network Controller (RNC) receives the paging message originated from the operation and administration devices (OAM) of the WCDMA system, and the paging message comprises the paged object and the paging reason, wherein, the information of paged object comprises the MTC device group ID and the paging reason is MTC system information acquisition.

In step S302, RNC determines the paged objects based on the group ID of the terminal devices; and determines the specific cell based on the information of paging area;

In step S303, RNC calculates the paging occasion based on the group ID of the terminal devices;

In step S304, RNC further determines that the paging reason is MTC system information acquisition; and generates the paging message comprising the MTC group ID and the paging reason indicated as MTC system information acquisition;

In step S305, RNC sends the paging message via the air interface to all the cells that the RNC administrates at the specific paging occasion. RNC sets the corresponding paging indication in the physical layer paging indication channel, and then sends the physical layer paging indication channel.

In conjunction with FIG. 4, activities of MTC terminal device comprise:

In step S401, the MTC terminal device calculates the paging occasion based on its own group ID;

In step S402, idle MTC terminal device wakes up at the specific paging occasion. At other times, idle MTC terminal device may turn off the receiver to preserve the battery power. The waked up MTC terminal device monitors the physical layer paging indication channel;

In step S403, MTC terminal device checks if there is a paging indication. If not, the MTC terminal device ends the paging procedure, switches back to the idle mode and waits for the next paging occasion to wake up and monitor physical layer paging indication channel; if paging indication is found, the MTC terminal device executes the step S404;

In step S404, MTC terminal device reads the paging message;

In step S405, MTC terminal device checks if there is its own group ID and/or device ID in the paging message. If not, the MTC terminal device ends the paging procedure, switches back to the idle mode and waits for the next paging occasion to wake up and monitor physical layer paging indication channel; if its own group ID and/or device ID is read, the MTC terminal device executes the step S406;

In step S406, MTC terminal device reads the paging reason and finds it out to be MTC system information acquisition; the paged MTC terminal device performs the system information acquisition procedure and updates the corresponding parameters delivered in the system information;

The fourth embodiment describes a paging procedure for LTE MTC devices. In this embodiment, MTC server expects to page a certain group of MTC devices in a certain paging area, the information of the paged objects is the MTC group ID, the information of the paging area is one or a plurality of TAs, i.e. a TA list; and the group of MTC devices are required to feedback a uplink report to the MTC server.

In conjunction with FIG. 3, activities of network comprise:

In step S301, eNB receives the paging message originated from the mobility management entity (MME) and the paging message comprises the information of paged object and the paging area; the information of paged object is the MTC group ID; the information of paging area is one or a plurality of TAs, i.e. a TA list; the group of MTC terminal devices are required to feedback a uplink report to the MTC server.

In step S302, eNB determines the paged objects based on the MTC group ID; and determines the specific cell based on the information of paging area;

In step S303, eNB calculates the paging occasion based on the group ID of the terminal device;

In step S304, eNB further determines that the paging reason is uplink report; and generates the paging message comprising the group ID of the paged MTC device, with the paging reason indicated in the panging message being uplink report;

In step S305, eNB sends the group-specific paging message via the air interface to all the corresponding cells according to the TA identification at the specific paging occasion. The corresponding cells are all the cells comprised in the range indicated by TA. The eNB sets the corresponding paging indication in the PDCCH and then sends the PDCCH.

In conjunction with FIG. 4, activities of terminal device comprise:

In step S401, the terminal device calculates the paging occasion based on its own group ID;

In step S402, idle terminal device wakes up at the specific paging occasion. At other times, idle terminal device may turn off the receiver to preserve the battery power. The waked up terminal device monitors the PDCCH;

In step S403, terminal device checks if there is a paging indication. If not, the terminal device ends the paging procedure, switches back to the idle mode and waits for the next paging occasion to wake up and monitor PDCCH; if paging indication is found, the terminal device executes the step S404;

In step S404, terminal device reads the paging message;

In step S405, terminal device checks if there is its own device ID and/or group ID in the paging message. If not, the terminal device ends the paging procedure, switches back to the idle mode and waits for the next paging occasion to wake up and monitor PDCCH; if its own group ID and/or device ID is read, the terminal device executes the step S406;

In step S406, MTC device reads the paging reason and finds it out to be uplink report; the paged MTC device generates the data required by the report and then forwards them to the MTC server.

It is should be further specified that for the case where the paging reason is indicated as that the terminal device needs to perform uplink report, the terminal device may generates a real-time reply message using the data reported and sends the real-time reply message to the target server of the communication system.

Specifically, after receives the paging message from network device, the terminal device checks in access stratum (AS) if the device ID and/or group ID comprised in the paging message match its own ones. If matched, the terminal device sends the device ID and/or group ID and the indication of the paging reason comprised in the paging message to non-access stratum (NAS).

After receives in NAS the paging message from AS, the terminal device checks if the received device ID and/or group ID match the ones it stores. If matched, terminal device generates a real-time reply message using the data reported and sends the real-time reply message to the target server according to the paging reason indication.

In the example above, the target server may be a MTC server; the terminal device may be a smart meter, an auto vendor, or a mobile unit, etc.; when the terminal device is a smart meter, the reported data is the metering result; when the terminal device is an auto vendor, the reported data may be the information of the goods out of stock; when the terminal device is a mobile unit, the reported data may be the location information of the vehicle.

The terminal device may send the real-time reply message to the target server in form of short message service (SMS) or multi-media service (MMS).

Specifically, the terminal device may choose the form in which the real-time reply message is going to be sent, based on the default application. For example, when the terminal device is required to report a metering result, it sends the real-time reply message to the target server in form of SMS; when terminal device is required to report data of video surveillance, it sends the real-time reply message to the target server in form of MMS.

Optionally, information of the target server can be stored in terminal device in a way of pre-configuring. As such, the paged terminal device may determine the server to which it should reply the real-time reply message.

It is should be specified that, the terminal device may send the real-time reply message to the target server in any form that is implementable using current techniques.

For example, in LTE/SAE system, the terminal device may send the real-time reply message to the server via eNB and using SGs interface, i.e. the interface between MME and MSC, based on the mode of the network to which it attaches; may send the real-time reply message to the server via the IP network.

In WCDMA system which is based on circuit switching, the terminal device may send the real-time reply message to the server via eNB, wireless network controller, MSC and SMS entity; in a WCDMA system based on packet switching, the terminal device may send the real-time reply message to the server using Universal Terrestril Radio Access Network (UTRAN), Serving GPRS Supporting Node (SGSN) and SMS entity.

In GSM system, the terminal device may send the real-time reply message to the server using eNB, eNB controller, MSC and SMS entity.

It should be understood by those skilled in the art. For clarity, there will be no more explanation.

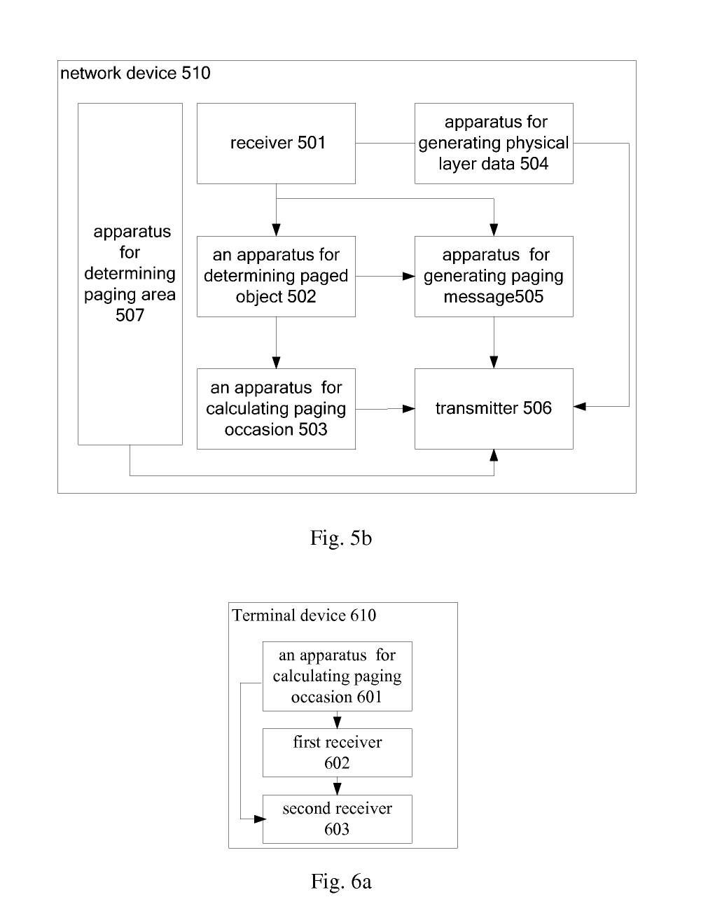

FIGS. 5a and 5b show structural diagrams of the network devices according to the two embodiments of the present invention. The network devices may be NB, eNB, network controller and other network devices that is applicable for the present invention.

In conjunction with FIG. 5a, the network device 500 comprises a reveiver 501, an apparatus for determining paged terminal device 502, an apparatus for calculating paging occasion 503, an apparatus for generating physical layer data 504, an apparatus for generating paging message 505 and a transmitter 506.

Specifically, the receiver 501 receives a paging initiation message which comprises the group ID and/or device ID of the paged terminal device. The paging initiation message may be originated from OAM device of the communication system in which network device 500 locates, or from a network device that locates upstream of the network device 500. The upstream network device is MME in case of LTE system; and is SGSN for the packet switching field of the WCDMA system; and is Mobile Services switching Center (MSC) for the circuit switching field of the WCDMA system based on packet switching.

The apparatus for determining paged terminal device 502 configured to determine the paged terminal device according to the paging initiation message received by the reveiver 501; the paged terminal device is determined according to its group ID and/or device ID.

The apparatus for calculating paging occasion 503, configured to calculate the paging occasion according to the device ID of the paged terminal device.

The apparatus for generating physical layer data 504, configured to generate physical layer control message comprising physical layer paging indication;

The apparatus for generating paging message 505, configured to generate paging message comprising the group ID and/or device ID of the paged terminal device determined by apparatus for determining paged terminal device 502.

The transmitter 506, configured to send the physical layer data generated by apparatus for generating physical layer data 504 and the paging message generated by apparatus for generating paging message 505 at the paging occasion determined by apparatus for calculating paging occasion 503.

Further, the paging initiation message received by reveiver 501 also comprises paging reason, and apparatus for generating paging message 505 further inserts the paging reason into paging message; the paging reason could be call setup, uplink report or system information acquisition and other paging reasons are not excluded. If the paging reason is call setup, uplink report, the paging initiation message are usually originated from the upstream network devices; if it is system information acquisition, the paging initiation message are usually originated from OAM devices of the system.

As showed in FIG. 5b, the network device comprises a receiver 501, an apparatus for determining paged terminal device 502, an apparatus for calculating paging occasion 503, an apparatus for generating physical layer data 504, an apparatus for generating paging message 505 and a transmitter 506, and further comprises an apparatus for determining the paging area 507. The receiver 501 of the network device 510 reveives a paging initiation message which also comprises a geographic area information of the paged terminal device, wherein, the geographic area comprises cell ID, TA ID, LA ID or RA ID. TA, RA and LA are administrated by the core network mobility and configured to enable the core network device to track, identify and control the geographic area where the terminal device is located, and which generally comprises one or a plurality of cells. The apparatus for determining the paging area 507 is configured to determine the paging area in which the paging message is sent, according to the area information of paged terminal device, and sends the paging area information to the transmitter 506; the transmitter 506 sends the physical layer information and paging message only in the paging area determined by the apparatus for determining the paging area 507.

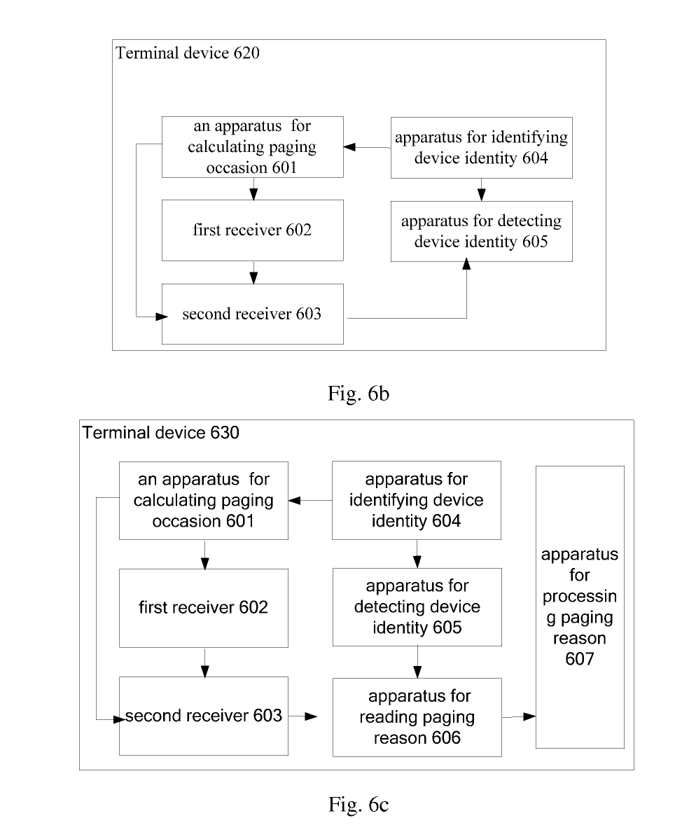

FIGS. 6a, 6b, and 6c respectively show structural diagrams of the terminal devices according to the three embodiments of the present invention.

As showed in FIG. 6a, the terminal device 610 comprises an apparatus for calculating paging occasion 601, configured to calculate a paging occasion;

a first receiver 602, configured to wake up at the paging occasion and receive the a physical layer paging indication which comes from the network device;

a second receiver 603, for receiving a paging message after the first receiver receives the physical layer paging indication.

As showed in FIG. 6b, the terminal device 620 comprises an apparatus for calculating paging occasion 601, a first receiver 602 and a second receiver 603, and further comprises:

an apparatus for identifying device identity 604, configured to identify of the terminal device according to group ID and device ID; like the current H2H user device, MTC device has its own device ID. MTC device may acquire its own MTC group by means of OAM and may store the group ID in SIM card of the device. The apparatus for calculating paging occasion 601 calculates the paging occasion according to the group ID of terminal device; the apparatus for detecting device identity 605, for detecting if the paging message received by the second receiver 603 comprises the group ID and/or the device ID of the terminal device.

As showed in FIG. 6c, the terminal device 630 comprises an apparatus for calculating paging occasion 601; a first receiver 602, a second receiver 603, an apparatus for identifying device identity 604 and an apparatus for detecting device identity 605, and further comprises:

an apparatus for reading paging reason 606, configured to read the paging reason comprised in the paging message, when the apparatus for detecting device identity detects the group ID and/or the device ID of the terminal device;

an apparatus for processing paging reason 607, configured to perform corresponding process according to the paging reason. When the paging reason is call setup, the apparatus for processing paging reason 607 initiates a procedure to set up connection with the network for call; when the paging reason is uplink report, the apparatus for processing paging reason 607 feedbacks a uplink report; when the paging reason is system information acquisition, the apparatus for processing paging reason 607 reads the system information and updates the parameters in the system information.

Further, an apparatus for generating real-time reply message 608 is also comprised. When the paging reason is uplink report, the apparatus for generating real-time reply message for generating real-time reply message 608 generates a real-time reply message comprising required data and then sends it to the target server via a transmitter 609. The terminal device may send the real-time reply message to the target server in form of short message service (SMS) or multi-media service (MMS). As to generating and sending the real-time reply message, it has been explained above, hence will not be repeated here.

The present invention proposes a method of paging terminal devices having group function, especially for paging MTC terminal devices. The solution in the invention is performed through a three-layer paging mechanism to narrow down the paging scope step by step. According to this invention, a single/a plurality of terminal device(s), a group of terminal devices or a single/a plurality of terminal device(s) belonging to a certain group may be paged. A plurality of terminal devices can be paged in a single paging message without bringing additional signaling load to the system. Idle terminal device wakes up at the specific paging occasion according to its group ID. The paging occasion is calculated based on the group ID, which may correspond to different applications of the terminal device; different service groups are assigned to different applications. The new solution in the invention solves the problems of current paging mechanism and provides an efficient and flexible solution for paging terminal devices having group function. The advantages include:

1) paging for only a specific terminal device having group function could be performed;

2) no negative impact on paging H2H device in the current network is introduced;

3) a single/a plurality of terminal device(s), a group of MTC devices or a single/a plurality of terminal device(s) in a certain group could be paged.

The present invention can be implemented by means of hardware, software, firmware or the combination thereof. Those skilled in the art could readily appreciate that, the present invention may be implemented in the statistic machine program configured on any signal carrying media suitable for data processing system. The signal carrying media could be transmission media or recordable media for machine readable information including magnetic media, optical media or other appropriate media. Examples of recordable media are magnetic disks or floppy disks for hard drive, CDs for optical drive, tapes and other media learned by those skilled in the art. It should be understood by those skilled in the art that, any communication device with appropriate programming apparatus can perform the steps of the present invention embodied in a program product.

Those skilled in the art could readily appreciate that the above embodiments of the present invention may be modified or changed without departing from the sprit of the present invention. The description in the disclosure is illustrative and should not be considered as limiting. The scope of the invention is only limited by the claims. Additionally, the term of “comprise” does not exclude the existence of other unit(s) or step(s); indefinite article “a/an” does not exclude the “a plurality” case. The plurality of units and apparatus described in the system claims may be implemented by a single unit or device using software or hardware. The term of “a first”, “a second” is just used for give a name rather than for representing some particular order.

1. A method of paging a terminal device in a communication system comprising network devices and terminal devices, wherein, the method comprises:
receiving, by the network device, a paging initiation message;
determining, by the network device, a paged terminal device;
determining, by the network device, a paging occasion;
sending, by the network device, a physical layer paging indication and a paging message at a time corresponding to the paging occasion, detecting, by the terminal device, the physical layer paging indication at the paging occasion;
receiving the paging message, by the terminal device, which detects the physical layer paging indication at the corresponding paging occasion.

2. A method according to claim 1, wherein the paging initiation message comprises the group ID and/or device ID of the paged terminal device, which is identified by its group ID or device ID; the paging occasion is determined by the group ID of the terminal device; the network device sends the group ID and/or device ID of the paged terminal device to the terminal device using the paging message; the terminal device which receives the paging message checks if the paging message comprises its group ID and/or device ID.

3. A method according to claim 2, wherein the paging initiation message further comprises an area information of the paged terminal device; and the network device determines a paging area in which the paging message is sent according to the area information of the paged terminal device; and sends the physical layer paging indication and the paging message to the paging area only.

4. A method according to claim 1, wherein the paging initiation message further comprises a paging reason; and based on the paging reason comprised in the paging initiation message, the network device further inserts the corresponding paging reason into the paging message, and informs the paged terminal device of the required operations; and the terminal device, which detects its group ID or device ID in the paging message, further acquires the paging reason indicated in the paging message, and then performs required procedures based on the paging reason.

5. A method according to claim 4, wherein the paging initiation message is originated from upstream network devices; the paging reason being call setup or uplink report; if the paging reason is call setup, the terminal device initiating a procedure to set up connection with the network for call; if the paging reason is uplink report, the terminal device feedbacking a uplink report.

6. A method according to claim 4, wherein the paging initiation message is originated from the operation and administration devices of the communication system; wherein the paging reason is system information acquisition, the corresponding operation of the terminal device according to the paging reason being reading the system information.

7. (canceled)

8. A network device which sends paging message in the communication system, wherein the communication system comprises at least one terminal device with a group ID and a device ID, the network device comprises:
a receiver, for receiving a paging initiation message, which comprises the group ID and/or device ID of the paged terminal device;
an apparatus for determining paged terminal device, configured to determine a paged terminal device based on the paging initiation message, the paged terminal device being determined by its group ID or device ID;
an apparatus for calculating paging occasion, configured to calculate a paging occasion based on the group ID of the paged terminal device;
an apparatus for generating physical layer data, configured to generate a physical layer control message which comprises a physical layer paging indication;
an apparatus for generating paging message, configured to generate a paging message which comprises the group ID and/or device ID of the paged terminal device;
a transmitter, for sending the physical layer information and the paging message at a time corresponding to the paging occasion.

9. A network device according to claim 8, wherein, the paging initiation message received by the receiver further comprises a paging reason, and the apparatus for generating paging message further inserts the paging reason into the paging message.

10. A network device according to claim 9, wherein the paging initiation message received by the receiver is originated from an network device that locates upper level of the network device; wherein the paging reason is setup call or uplink report.

11. A network device according to claim 9, wherein the paging initiation message received by the receiver is originated from the operation and administration devices of the communication system; wherein the paging reason is system information acquisition.

12. A network device according to claim 8, wherein, the paging initiation message received by the network device further comprises an area information of the paged terminal device; and the network device also comprises a paging area determing apparatus, which is configured to determine a paging area, in which the paging message is sent, according to the area information of the paged terminal device; and according to the paging area exported by the paging area determing apparatus, the transmitter sends the physical layer information and the paging message to the paging area only.

13. (canceled)

14. A terminal device which comprises:
an apparatus for calculating paging occasion, configured to calculate a paging occasion;
a first receiver, for receiving a physical layer paging indication from a network device at the paging occasion;
a second receiver, for receiving a paging message after the first receiver receives the physical layer paging indication.

15. A terminal device according to claim 14, comprising:
an apparatus for identifying device identity, configured to identify the ID of the terminal device, including group ID and device ID;
an apparatus for detecting device identity, configured to detect if the paging message comprises the group ID and/or the device ID of the terminal device;
further, the apparatus for calculating paging occasion is for calculating the paging occasion based on the group ID of the terminal device.

16. A terminal device according to claim 14, comprising:
an apparatus for reading paging reason, configured to read the paging reason comprised in the paging message, when the apparatus for detecting device identity detects the group ID and/or the device ID of the terminal device;
an apparatus for processing paging reason, configured to perform corresponding process according to the paging reason.

17. A terminal device according to claim 16, wherein, when the paging reason is call setup, the apparatus for processing paging reason initiates a procedure to set up connection with the network for call.

18.-20. (canceled)
